(19) United States
(12) Patent Application Publication
(10) Pub. No.: US 2026/0044394 A1
(43) Pub. Date: Feb. 12, 2026

(54) EXTENSIBLE FRAMEWORK FOR CENTRALIZED ANALYSIS AND REPORTING OF DATA ASSOCIATED WITH DISTRIBUTED AND HETEROGENEOUS APPLICATIONS

(71) Applicant: Open Text SA ULC, Halifax (CA)

(72) Inventors: Bryan Adam JOYNER, Sachse, TX (US); Daniel Joseph POTKALESKY, Garland, TX (US); Caleb Rhoads SPRING, Menlo Park, CA (US)

(21) Appl. No.: 18/801,042

(22) Filed: Aug. 12, 2024

(51) Int. Cl. G06F 9/54

(52) U.S. Cl. CPC G06F 9/542; G06F 9/546

(57) ABSTRACT

Systems and methods for extensible management platforms adapted for analysis and reporting of data associated with heterogeneous applications deployed across multiple enterprises are disclosed.

### TECHNICAL FIELD

This disclosure relates generally to the field of distributed networked computing environments. Specifically, the disclosure relates to systems and methods for the centralized management, analysis, and reporting of data related to applications within a distributed and networked computer environment. More specifically, embodiments as disclosed pertain to system and methods for centralized management, analysis, and reporting of data associated with distributed and heterogeneous applications that employ an extensible framework to allow for simple correlation and reporting of events across those applications while also allowing new or updated applications to be easily incorporated into the management, analysis, and reporting system.

### BACKGROUND

In the modern world enterprises or entities (e.g., any organization), including those with independent and geographically dispersed units, commonly use many types of software applications. These applications may be quite heterogeneous and can operate according to a wide variety of different architectures or configurations where those architectures and configurations may be quite complex. For example, such applications may be deployed on-premise, may be cloud based, may be standalone applications or operate according to a service architecture, etc. Each of the applications can, additionally, have unique, evolving, configurations based on the evolution of the application itself, the alteration of the computing environment in which the applications are deployed, or other considerations.

It is thus difficult to manage these applications (e.g., obtain, analyze, or present, data on such applications). As these applications may be differently architected, deployed on different platforms, have different reporting mechanisms, or be otherwise heterogeneous, the coordination of the reporting and correlation of the heterogeneous data from different ones of these different applications is a highly intensive process. More specifically, in most management (e.g., analysis and reporting) platforms there must be a proprietary processing mechanism for data from each individual application that is supported, such that the particular format or data utilized or reported by that application may be accommodated. Additionally, as the data from these different applications may be in a different format, be tagged in a different manner, or be altogether different in a number of other ways, the correlation of data amongst different applications is incredibly complex, slow, and resource intensive.

Complicating this situation is that, despite their heterogeneous nature, different applications in these computing environments may be provided by the same provider. Thus, a provider entity may provide multiple (e.g., different) applications to an enterprise, where that provider entity may not be responsible for developing, supporting, or updating the application. This is often the case, for example, in software distribution or support arrangements where one party may develop, and support the update of, the application (e.g., write and develop the code for the applications and corresponding updates) while another party (e.g., the provider entity) may be responsible for deploying those applications in an enterprise's computing environment and supporting the deployment of those applications in association with that particular enterprise. Thus, in many scenarios, a provider entity may desire to obtain reporting or other associated data on multiple heterogeneous applications deployed by that provider within an enterprise.

As may be realized, however, such providers may provide these same applications (or some set of applications including at least some of the same applications) to other enterprises as well. Thus, the provider party may not only desire to obtain reporting or other data associated with applications within a particular enterprise, but may also wish to obtain reporting or other data from multiple heterogeneous applications deployed across different enterprises by that provider. Additionally, the provider may want to obtain such data in an aggregated manner such that associated data across applications or enterprises may be correlated and presented together, while still allowing that provider to access, or otherwise determine, data from individual applications, and data from individual applications associated with particular enterprises in which that application is deployed.

Heretofore, reporting and management system mechanisms for applications have been specifically tailored to individual applications or a particular enterprise's suite of applications. Additionally, these reporting and management systems may require proprietary processing mechanisms for each individual application support such that the particular format or data utilized or reported by that application may be accommodated. Because of this design, among other reasons, these previous management and reporting systems lack extensibility. To support reporting on an additional application (e.g., a new application) the (e.g., new) application must be significantly altered or initially designed with such reporting in mind, or the management and reporting system must be altered to accommodate the data (e.g., the type, format, etc.) reported by the application. Moreover, because of the variety of the (e.g., formats and types) data coming from these applications, correlation of data among applications and across enterprises in which those applications are deployed has proved quite difficult. This is especially so given an environment where a provider entity may desire such a management platform but may not be responsible for the development or updating of the applications themselves.

Accordingly, there is a need to provide simple and efficient platforms for the centralized management of data associated with heterogeneous applications deployed in a distributed computing environment. And, in particular, simple and efficient platforms for such centralized management and reporting that are easily extensible and that can correlate data for these multiple heterogeneous applications across enterprises for providers of such applications.

### SUMMARY

To continue with the above discussion, it will be recalled that heterogeneous applications may be deployed across an enterprise's computing environment, where those different applications environments may be provided by a provider (e.g., different than the entity). Thus, a provider may provide multiple (e.g., different) applications to an enterprise, where that provider entity may not be responsible for developing, supporting, or updating the application. This provider may therefore wish to obtain reporting or other associated data on its applications deployed in an enterprise.

Providers of this type may, however, provide these same applications (or some set of applications including at least some of the same applications) to other enterprises as well. Because of this, a provider may not only desire to obtain reporting or other data associated with applications within a particular enterprise, but may also wish to obtain reporting or other data from multiple heterogeneous applications deployed across different enterprises by that provider. Additionally, the provider may want to obtain such data in an aggregated manner such that associated data across applications or enterprises may be correlated and presented together, while still allowing that provider to access, or otherwise determine, data from individual applications, and data from individual applications associated with particular enterprises in which that application is deployed.

Previous management systems for reporting such data have been inadequate for this purpose. In particular, previous management systems lack extensibility. To support reporting on additional applications (e.g., a new application or newly deployed application) the application must be significantly altered or initially designed with such reporting in mind, or the management system must be altered to accommodate the data reported by the application. Moreover, the variety of the data involved has made management of this data extraordinarily difficult. Accordingly, there is a need to provide simple and efficient platforms for the centralized management of data associated with heterogeneous applications deployed in a distributed computing environment.

Embodiments of a management platform as presented herein may address these needs, among others as will be understood from a review of the disclosure. In one embodiment, a management platform may include an entity database that associates each provider with one or more enterprises. As events are received from applications at the management platform these events may be stored in an event database such that the events are stored in association with a corresponding enterprise and provider. By virtue of an enterprise's association with a provider, these events may also be associated with the provider.

Embodiments of a management platform analyze events to correlate events (e.g., associated with the same provider) with one another based on one or more criteria. These criteria may be internal criteria associated with (e.g., included in) the events themselves. For events that are associated with one another based on a criteria, an aggregation (e.g., an aggregation object) may be defined at the management platform. This aggregation may thus be associated with a provider and a set of events, where each of these events is associated with the same provider (but may be associated with multiple heterogeneous applications deployed across one or more enterprises).

Embodiments of a management platform may employ an easily extensible framework such that new applications may be incorporated in the management framework with little effort without requiring individual applications to have knowledge of the provider that deployed the application or the enterprise or domain in which they are deployed. This framework may also allow applications to individually control the events to which a user has access and the information that may be accessed in association with such events, including allowing those applications to easily add, update or remove events.

In some embodiments, therefore, events from a plurality of heterogeneous applications deployed across one or more enterprises (e.g., multiple distinct enterprises) may be received at a management platform, where each event identifies an enterprise and a provider of an application associated with the event. These events from the multiple heterogeneous applications may be stored at the management platform. A request can be received from a provider identifying the provider. Based on the received request, events associated with the provider as received from the multiple heterogeneous applications deployed across the one or more enterprises may be identified and presented to the provider in a provider event interface.

In one embodiment, each event includes a message included by the application, and presenting the identified events comprises presenting the first messages of the identified events.

Embodiment may also include determining that one event of the events includes an aggregation associated with a category. This aggregation may be stored at the management platform in association with a provider and the first event. Another event can include another aggregation associated with the category. It can be determined that this second event is associated with the stored aggregation (e.g., based on the category or a provider associated with both events). This second event can be stored in association with the stored aggregation and the aggregation presented to the provider in the provider event interface. These events may be from heterogeneous applications deployed in distinct enterprises.

Moreover, according to some embodiments, the stored aggregation can include a message as included in the first received event and the second aggregation of the second received event may include a second message. The second message may be used to replace the message as included in the aggregation of the first received event and used when presenting the stored aggregation.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIGS. 1A and 1B (collectively FIG. 1) is a block diagram of a distributed networked computer environment including one embodiment of a management platform.

FIGS. 2A and 2B are depictions of events in accordance with some embodiments.

FIG. 3 is a diagram of one embodiment of a provider event interface.

FIG. 4 is a diagram of an example of an aggregation area of a provider event interface in accordance with some embodiments.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Before delving into more details regarding the specific embodiments disclosed herein, some context may be helpful. As discussed, large enterprises (e.g., any organization), including those with independent and geographically-dispersed units, commonly use many types of software applications (services). Each of the applications can, additionally, have complex, unique, and configurations.

It is thus difficult to manage these applications (e.g., obtain, analyze, or present, data on such applications). As these applications may be differently architected, deployed on different platforms, have different reporting mechanisms, or be otherwise heterogeneous, the coordination of the reporting and correlation of the heterogeneous data from different ones of these different applications is a highly intensive process. More specifically, in most management (e.g., analysis and reporting) platforms there must be a proprietary processing mechanism for data from each individual application that is supported, such that the particular format or data utilized or reported by that application may be accommodated. Additionally, as the data from these different applications may be in a different format, be tagged in a different manner, or be altogether different in a number of other ways, the correlation of data amongst different applications is incredibly complex, slow, and resource intensive.

Complicating this situation is that, despite their heterogeneous nature, different applications in these computing environments may be provided by the same provider. Thus, a provider entity may provide multiple (e.g., different) applications to an enterprise, where that provider entity may not be responsible for developing, supporting, or updating the application. This is often the case, for example, in software distribution or support arrangements where one party may develop, and support the update of, the application (e.g., write and develop the code for the applications and corresponding updates) while another party (e.g., the provider entity) may be responsible for deploying those applications in an enterprise's computing environment and supporting the deployment of those applications in association with that particular enterprise. Thus, in many scenarios, a provider entity may desire to obtain reporting or other associated data on multiple heterogeneous applications deployed by that provider within an enterprise.

As may be realized, however, such providers may provide these same applications (or some set of applications including at least some of the same applications) to other enterprises as well. Thus, the provider party may not only desire to obtain reporting or other data associated with applications within a particular enterprise, but may also wish to obtain reporting or other data from multiple heterogeneous applications deployed across different enterprises by that provider. Additionally, the provider may want to obtain such data in an aggregated manner such that associated data across applications or enterprises may be correlated and presented together, while still allowing that provider to access, or otherwise determine, data from individual applications, and data from individual applications associated with particular enterprises in which that application is deployed.

Heretofore, reporting and management system mechanisms for applications have been specifically tailored to individual applications or a particular enterprise's suite of applications. Additionally, these reporting and management systems may require proprietary processing mechanisms for each individual application support such that the particular format or data utilized or reported by that application may be accommodated. Because of this design, among other reasons, these previous management and reporting systems lack extensibility. To support reporting on an additional application (e.g., a new application) the (e.g., new) application must be significantly altered or initially designed with such reporting in mind, or the management and reporting system must be altered to accommodate the data (e.g., the type, format, etc.) reported by the application. Moreover, because of the variety of the (e.g., formats and types) data coming from these applications, correlation of data among applications and across enterprises in which those applications are deployed has proved quite difficult. This is especially so given an environment where a provider entity may desire such a management platform but may not be responsible for the development or updating of the applications themselves.

Accordingly, there is a need to provide simple and efficient platforms for the centralized management of data associated with heterogeneous applications deployed in a distributed computing environment. And, in particular, simple and efficient platforms for such centralized management and reporting that are easily extensible and that can correlate data for these multiple heterogeneous applications across enterprises for providers of such applications.

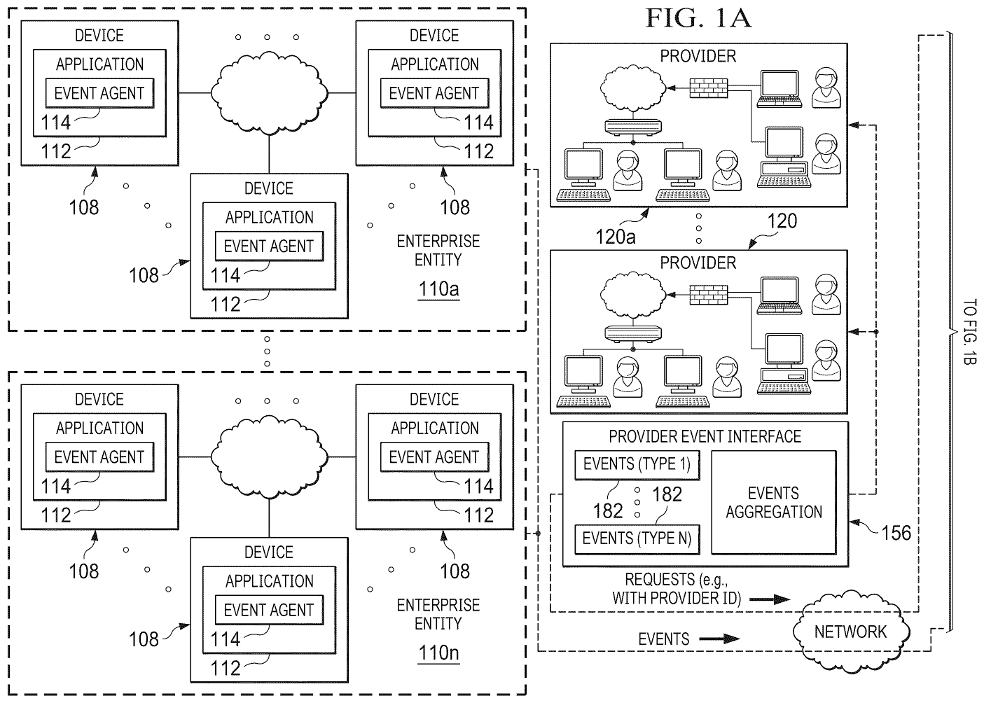

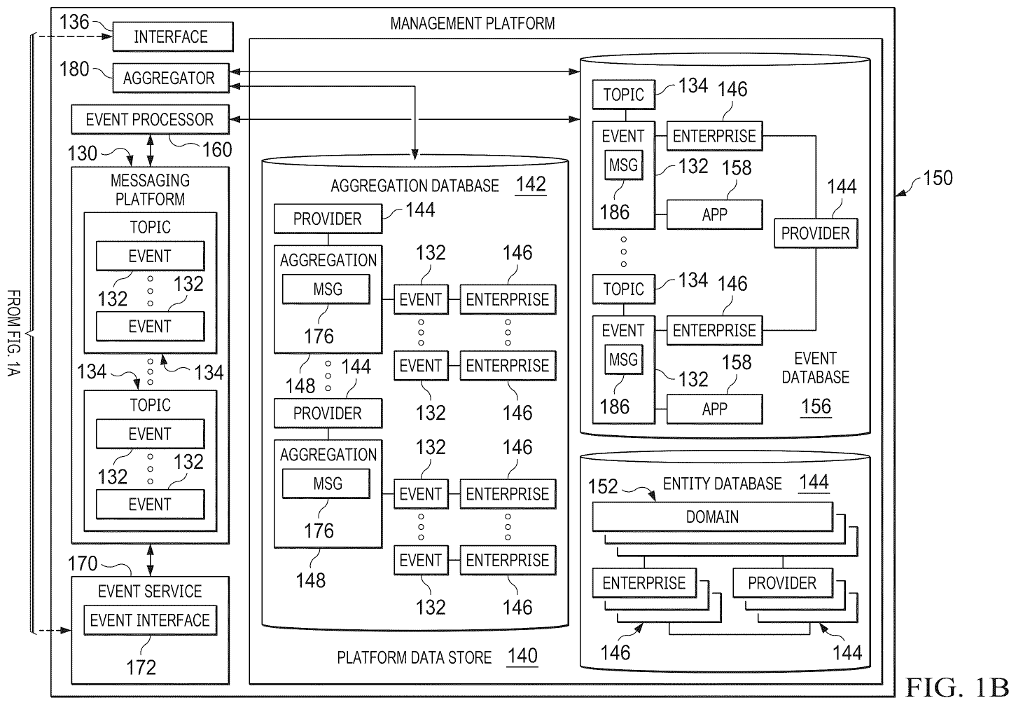

Embodiments of a centralized configuration system as disclosed herein may address these needs, among others, and provide other additional advantages as will be understood. Referring to FIG. 1 then, one embodiment of just such a management platform 150 deployed in association with one or more enterprise environments 110 in a distributed and networked computer environment is depicted. Applications 112 may be deployed across an enterprises' computing environment 110. Thus, an enterprise entity computing environment 110 (or just “enterprise”) may include a number of networked (virtual or physical) devices 108 where a number of applications 112 may be deployed on those devices 108 throughout the enterprise's environment 110. These applications 112 may be heterogeneous, including different applications, different versions of the same application, differently configured versions of the same applications, etc. Enterprise 110 may also include one or more domains (e.g., subsets or division of administrative autonomy of a network, such as associated with a particular LAN, WAN, portion of the Internet, IP address, etc., including for example a division of a network associated with a domain name (e.g., enterpriseeentity.com)

In some cases, heterogeneous applications 112 in an enterprise entity 110's computing environments may be provided by provider entity 120 (or just “provider”). Thus, provider 120 may provide multiple (e.g., different) applications 112 to an enterprise 110, where that provider 120 may not be responsible for developing, configuring, supporting, updating, etc. the application. Moreover, provider 120 may not only provide these heterogeneous applications 112 for a single enterprise 110, but may provide those applications 112 across multiple different enterprise's 110 (e.g., where there may be no relationship between those enterprises 110a-110n). Thus, for example, a single provider 120a may have multiple different types of applications 112 deployed across different enterprise's 110.

As noted, each of these different types of applications 112 may perform a different functionality. Moreover, even applications 112 of the same type may be differently configured across different enterprises or have different functionality of those applications supported, enabled or configured. Provider 120 responsible for those deployed applications 112 may desire to obtain reporting or other associated data on these deployed applications 112. In particular, provider 120 may not only desire to obtain reporting or other data associated with applications 112 within a particular enterprise 110, but may also wish to obtain reporting or other data from multiple heterogeneous applications 112 deployed across different enterprises 120a-120n by that provider 120. Additionally, the provider may want to obtain such data in an aggregated manner such that associated data across applications 112 or enterprises 110 may be correlated and presented together, while still allowing that provider 120 to access, or otherwise determine, data from individual applications 112, and data from individual applications 112 associated with particular enterprises 110 in which that application 112 is deployed. Such desires are not easily addressed. These applications 112 may report different types of data on different events in different manners, making the reception, analysis (including correlation) and reporting of this data problematic.

Embodiments of management platform 150 may thus be deployed in these types of environments for management (e.g., analysis and reporting) of data from these multiple heterogeneous applications 112 deployed across different enterprises 110. Management platform 150 may include one or more (physical or virtual) servers or other computing devices (e.g., in one or more containers) deployed at a third party (e.g., not a provider or enterprise) such as in a cloud based computing platform. Management platform 150 may also include a platform data store 140 include an entity database 154 that associates each provider 144 (e.g., an identifier for provider 120) with one or more enterprises 146 (e.g., an identifier for an enterprise 110) and enterprises 146 with one or more domains 152. As events 132 are received from applications 112 deployed across enterprises 110, event processor 160 may augment events 132 (e.g., with data obtained for that event 132 such as data from entity database 154) and stored events in event database 156 at management platform 150 such that events 132 are stored in association with a corresponding enterprise 146, provider 144 and, in some embodiments, with a corresponding application 158 (e.g., identifier for an application 112). By virtue of enterprise 146's association with provider 144 these events 132 may thus be associated with provider 144 as well.

Aggregator 180 may analyze events 132 in event database 156 to correlate events 132 (e.g., events 132 associated with the same provider 120) with one another based on one or more criteria. These criteria may be internal criteria associated with (e.g., included in) the events themselves. For events 132 that are associated with one another based on a criteria, aggregator 180 may define an aggregation (e.g., an aggregation object) 148 in aggregation database 142 in platform data store 140. This aggregation 148 may thus be associated with a provider 144, and a set of events 132, where each of these events 132 is associated with the same provider 144 (but may be associated with multiple heterogeneous applications 112 deployed across one or more enterprises 110). Each of the events 132 may also be associated with a corresponding enterprise 146 for which the provider 120 (associated with provider (identifier) 144) that supports the application that generated that event 132.

Management platform 150 also provides interface 136 through which a provider 120 may access provider event interface 156. This provider event interface 156 may be a browser based interface or the like such that interface 136 may be a REpresentational State Transfer (REST) interface that may be accessed by users at provider 120 through a browser to view or interact with events 132, aggregations 148, or related data, associated with that provider 120. Such an event interface 156 may, for example, have one or more areas 182 for presenting events 132, where each area 182 may be adapted to present events 132 of a certain type (or messages, notifications or other data regarding such events 132) in that area 182.

Event interface 156 may also include aggregation area 184 where aggregations 148 for that provider 120 may be presented (e.g., messages, notifications, or other data regarding such aggregations 148), including a message or count of events 132 associated with such aggregations 148. A user may interact with the events 132 presented in an event area 182 or an aggregation 148 presented in aggregation area 184 (or events 132 presented in aggregation area 184) to obtain more data on such events 132 or aggregations 184, including, for example, the individual events 132 associated with each aggregation 184, sorting events 132 of an event type or aggregation 184 (or multiple aggregations 184) by type or application 112 or other sort, correlate or otherwise interact with or manipulate such event or aggregation data.

As discussed, it may be desired to allow the framework for implementing management platform 150 to be easily extensible such that new applications 112 may be incorporated in the management framework with little effort without requiring individual applications to have knowledge of the provider 120 that deployed them or the enterprise 110 or domain in which they are deployed, while simultaneously allowing applications 112 to individually control the events that a user has access to (e.g., and the information that may be accessed in association with such events 132), including allowing those applications 112 to easily add, update or remove events 132.

To implement such a framework therefore, embodiments may employ messaging platform 130 (e.g., a messaging platform such as Azure Event Grid, RabbitMQ, etc.) in association with event agents 114 in applications 112. These events agents 114 are adapted to provide events 132 as messages to one or more message topics 134 provided by messaging platform 130. These topics 134 may include, for example, tasks or alerts. A task may be an item that needs attention. These tasks can be further subdivided into tasks that are associated with the provider 120 or tasks associated with an enterprise 110 (e.g., the enterprise 110 in which the application 112 is deployed).

Management platform 150 thus includes an event service 170. Event service 170 may include one or more event interfaces 172 for receiving events 132 of different types through the corresponding event interface 172. Thus, an event agent 114 in application 112 may provide an event 132 through an event interface 172 of event service 170 (e.g., available at a location such as a URL or the like), where by providing the event 132 to through the event interface 172 the event 132 is published as a message to a corresponding topic 134 in messaging platform 130.

Messaging platform 130 can thus receive events 132 as messages from applications 112 where those events 132 are associated with topics 134 (e.g., tasks or alerts). Events 132 associated with topics 134 can thus be provided to subscribers to those topics 134. In one embodiment, for example, there may be an event processor 160 for each type of event 132 such that the event processor 160 for the type of event 132 may subscribe to the topic 134 corresponding to that event type and thus receive the messages for events 132 of that event type, augment those events 132 if needed, and stored these events 132 in event database 156.

To facilitate the ease of implementation of event agents 114 or the incorporation of event agents 114 into applications 112, the format for events 132 may be structured similarly, or identically, for events 132 of different types and require only a limited amount of data. These events 132 may also be in a (e.g., serialized) data format such as JavaScript Object Notation (JSON). According to one embodiment, therefore, an event 132 may be structured to include fields for an identifier for the enterprise (also referred to herein as a “customerid”) that may be an identifier (Globally Unique Identifier (GUID)) associated with the enterprise 110, an identifier for provider 120 that provided the application 112 (also referred to as a “partnerid”) that generated the event 132 (e.g., a GUID for provider 120), an identifier for a domain (e.g., a domain name) of the enterprise 110 in which the application 112 that generated the event 132 operates (e.g., a “domain”), and an identifier (e.g., “product”) for the application 112 which generated the event 132.

The fields of an event 132 may also include a tracking identifier (e.g., “trackingId”) that may be unique to the event 132 and used to identify that event 132 such that it can be removed, updated, etc. or otherwise subsequently identified and an action field to identify an action for that event (e.g., to add the event, remove the event 132 identified by the trackingId, update the event identified by the trackingId, etc.). The fields of an event 132 also include a priority for the event (e.g., high or low), and a link field. This link field may include a link (e.g., URL) such that when the event 132 is presented in an event interface 156 for a provider 156, this URL may be presented so that when the user interacts with the presented event 132 the user can navigate to this link. In this manner, the application 112 gets to specify the location to which a provider 120 may be directed and gets to determine what information is included at the location specified by that link.

The event 132 may also include an aggregation (e.g., an aggregation object) and a message (e.g., a message object). A message may be an object specifying one or more locales (e.g., defining a language or region) and associated message text for that locale. In this way, a message structure (e.g., as included in an event 132) may be utilized anywhere a message may appear, such as when an event 132 is associated with an aggregation 148. Moreover, by using an event 132 with a message of this type, the application 112 generating the event 132 may be allowed to put whatever message text is desired in an event 132 without loss of generality, as the message may be structured (and processed) similarly regardless of the content of the message text.

An aggregation 148 may include a category including a category name. A category name may be any key or other identifier desired to identify a category. Thus, categories for aggregations 148 may not be confined or constrained to a particular set of (e.g., predefined) categories but may instead include almost any categories desired or defined by application 112 creating events 132. The aggregation 148 may also include an array of messages. As noted above, each of these messages may be an object specifying one or more locales and associated message text for that locale. In some embodiments, it may be allowed to specify a variable (e.g., “{N}”) for dynamic replacement with data when creating or updating an aggregation 148 in aggregation database 142 or when presenting a message for an aggregation 148 in aggregation area 184 of provider event interface 156. A variable may be associated with, for example, the number of events 132 or messages associated with an aggregation 148.

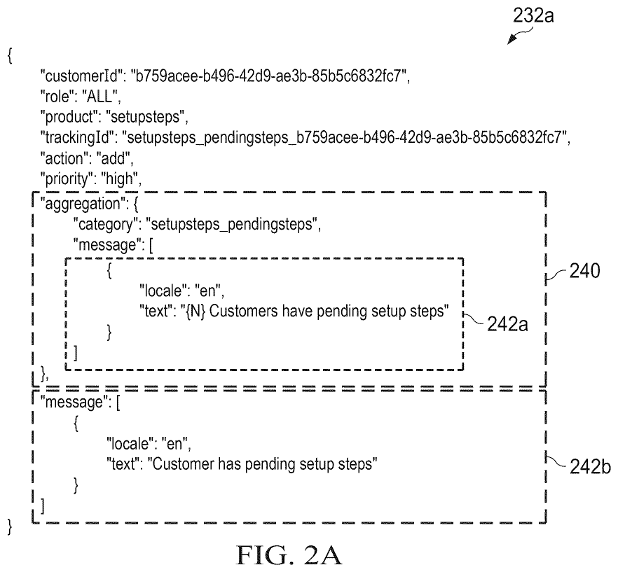

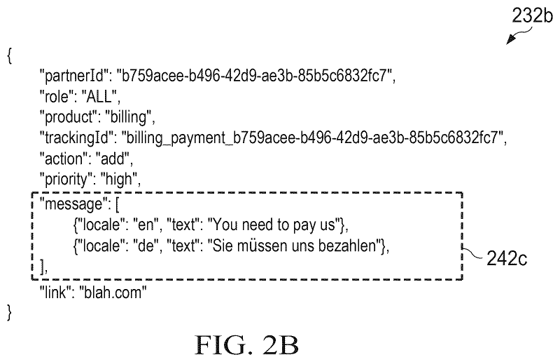

Two examples of events according to embodiments are depicted in FIGS. 2A and 2B. Notice here that the example event 232a in FIG. 2A, the event 232a includes an aggregation 240 (e.g., an aggregation object). This aggregation 240 included a category field with a value of “setupsteps_pensingsteps”. The aggregation 240 also includes a message 242a that includes a locale of “en” and message text of “{N} Customers have pending setup steps”. Note this message 242a of aggregation 240 a variable (e.g., “{N}”) for dynamic replacement with data when creating or updating an aggregation (e.g., an aggregation 148) and presenting an aggregation (e.g., an aggregation 148) including that event 232a (e.g., in an aggregation area of a provider event interface). Similarly, event 232a may include message 242b for the event 232a. This message 242b includes a locale of “en” and message text of “Customer has pending setup steps”. This text may be used when presenting the event 232a (e.g., in an event area of a provider event interface).

In the example of FIG. 2B, event 232b includes a message 242c (e.g., message object) that included two locales and associated messages: a first locale of “en” and message text of “You need to pay us” and a second locale of “de” and message text of “Sie müssen uns bezahlen”. Thus, each of these locales may be included in any context of a message platform that includes this message 242c or event 232b and the appropriate text of the message 242c may be used when presenting the event 232b depending on the location (e.g., from which an event provider interface is being accessed.

Returning to FIG. 1, thus, when events 132 are received from applications 112 deployed across enterprises 110 through event interface 172 of event service 170 they may be placed on a corresponding message topic 134 (e.g., message queue) of messaging platform 130. Events 132 (e.g., messages including events 132) are consumed from the message topic 134 by event processor 160. Event processor 160 may augment these events 132 (e.g., with data obtained for that event 132 such as data from entity database 154) and store events 132 in event database 156 at management platform 150 such that events 132 (and any included message 186 for those events 132) are stored in association with a corresponding enterprise 146, provider 144 and, in some embodiments, with a corresponding domain 152 or application 158 (e.g., identifier for an application 112) and topic 134. This augmentation may be done based on data in the event 132 such that the event 132 includes the identifier for the enterprise 110 (e.g., “customerId”), provider 120 (e.g., “partnerId”) or domain associated with the enterprise 110. This augmentation process may include obtaining one or more of the values for the identifier for the enterprise 110 (e.g., “customerId”), provider 120 (e.g., “partnerId”) or domain associated with the enterprise 110 from an event 132 and accessing entity database 154 to obtain any missing values in the event 132 for identifiers for the enterprise 110 (e.g., “customerId”), provider 120 (e.g., “partnerId”) or domain associated with the enterprise 110 and augmenting the event 132 with those values before storing the event 132 in event database 156. In this manner, events 132 in event database 156 can be associated with the entity 146 and provider 144.

In one embodiment, event processor 160 may also evaluate the action field of event 132 to identify an action for that event 132. If the action field specifies an add, the event processor 160 may just add the event 132 to the event database 156. If the action field specifies a removal, the event processor 160 may determine if there are any events 132 in event database 156 corresponding to the tracking identifier of the received event 132 and remove any such events 132 from event database 156. If the action field specifies a update, the event processor 160 may determine if there are any events 132 in event database 156 corresponding to the tracking identifier of the received event 132 and update any such events 132 in event database 156 with the values for the fields (or a subset of the fields) of the obtained event 132.

Aggregator 180 may analyze events 132 in event database 156 to correlate events 132 (e.g., events 132 associated with the same provider 144) with one another based on one or more criteria. Specifically, aggregator 180 may process events 132 (e.g., as events 132 are removed from message queues for topic 134 and processed by event processor 160, or events 132 obtained from event database 156) to determine aggregations 148 and store these aggregations 148 in aggregation database 142. According to one embodiment, any aggregation included in the originally received event 132 may be removed before the event 132 is stored in event database 156.

In particular, aggregator 180 may evaluate events 132 to determine if that event 132 includes an aggregation 148 (e.g., an aggregation object such as aggregator object 240 of FIG. 2A). The aggregator 180 may determine if there is a corresponding aggregation 148 in aggregation database 142. Such a corresponding aggregation 148 may be, for example, associated with the same provider 144 as the event 132 from which the aggregation 148 was obtained and also be associated with the same criteria as the aggregation 148 obtained from the event 132. Such a criteria may be the “category” as included in the aggregation 148.

Thus, in one embodiment, aggregator 180 may determine a provider 144 (e.g., an identifier for provider 120) from the received event 132 and determine the category of the aggregation 148 obtained from that event 132. The aggregator 180 can then access aggregation database 142 to determine if there are any aggregations 148 in aggregation database 142 that are associated with both the same provider 144 and the same category as the obtained aggregation 148. If a matching aggregation 148 is found in the aggregation database 142 (e.g., an aggregation object associated with the same provider and category is already stored in aggregation database 142), aggregator 180 may update this found aggregation 148 by associating the event 132 with that aggregation 148 in aggregation database 142. In one embodiment, for example, aggregator 180 may include an identifier for aggregation 148 in each event 132 associated with that aggregation 148.

Moreover, in one embodiment, aggregator 180 may update any message 176 associated with the aggregation 148. Such an update may entail determining any locales, and associated message text for those locales, from any message included in aggregation 148 obtained from the event 132, and comparing these obtained locales to the locales and associated message text included in message 176 of matching aggregation 148 found in aggregation database 142. For any locales from the message obtained from the event 132 that match locales of the matching aggregation 148 found in aggregation database 142, the current message text of the message obtained from the event 132 may be used to replace the message text for that locale in message 176 of matching aggregation 148 in aggregation database 142. For any locales in the message obtained from aggregation 148 of event 132 that are not matched in message 176 of matching aggregation 148, those locales and associated message text may be added to message 176 of matching aggregation 148 in aggregation database 142.

If the aggregator 180 does not find a matching aggregation 148 in aggregation database 142 for an aggregation obtained from an event 132 (e.g., an aggregation object associated with the same provider and category as the obtained event 132 is not already stored in aggregation database 142), the aggregator 180 may store the aggregation 148 obtained from the event 132 in aggregation database 142 as a new aggregation 148, where that new aggregation 148 is associated with the event 132 from which it was obtained (including the provider a44 and entity 146 associated with that event 132). Thus, the newly stored aggregation 148 will have any messages 176 (e.g., message objects) associated with that aggregation 148 as obtained from that event 132.

Accordingly, when a user at provider 120 access provider event interface 156 (e.g., through a browser on their device), the provider event interface 156 may make a request for events 132 or aggregations 148 to interface 136 at management platform 150, where that request includes an identifier for provider 120 (i.e., provider 144). When this request is received, interface 136 may obtain events 132 associated with provider 144 from event database 156 or aggregations 148 associated with provider 144 from aggregation database 148 and render these events 132 or aggregations 148 in provider event interface 156. In particular, events 132 (associated with the provider 144) may be obtained and rendered in a corresponding event area 182 of the provider event interface 156 (e.g., for the type of that event 182). The rendering of an event 182 may include presenting a message 186 associated with that event 132 (e.g. as included in the received event 132) or associating the presented event 132 with a link (e.g., as included in the received event 132) such that interaction with the presented event 132 may navigate a user access provider event interface 156 to that link. Aggregations 148 (associated with provider 144) may also be obtained and rendered in aggregation area 184. The rendering of an aggregation 148 may include presenting one or more messages 186 associated with that aggregation 148 and a count of the number of events 132 associated with that aggregation. When rendering a message 186 associated with an event 132 interface 132 may dynamically replace any variable in that message 186 (e.g., “{N}”) with data (e.g. number of events 132 associated with that aggregation 148) when rendering the message for provider event interface 156.

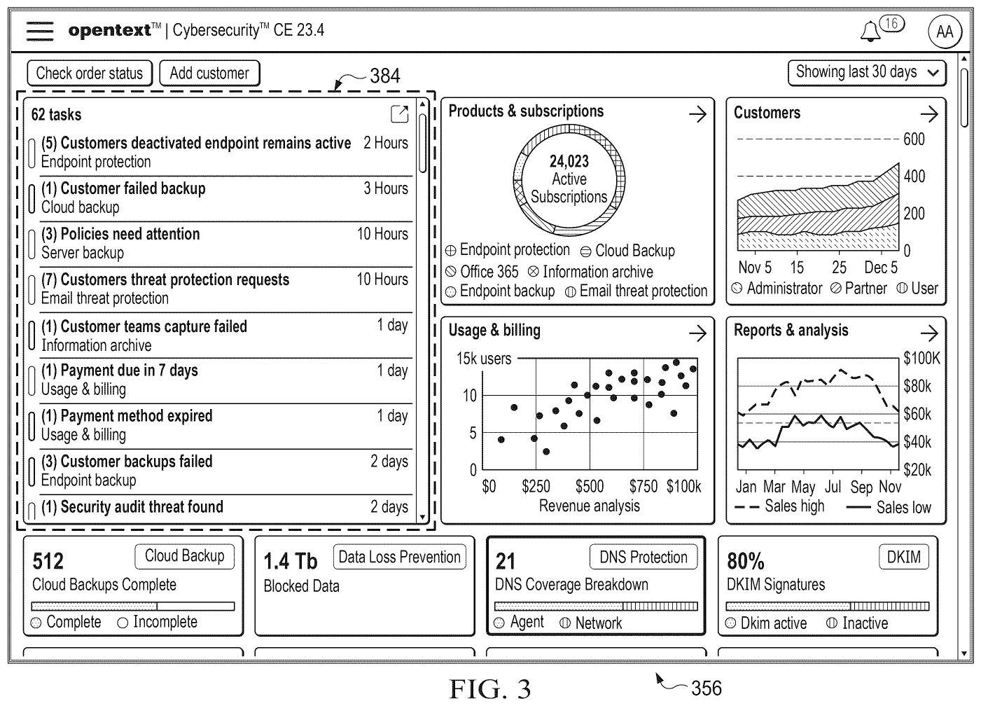

FIG. 3 depicts one example of a provider event interface 356 according to an embodiment. Here, interface 356 may include aggregation area 384 where aggregations corresponding to a provider are presented.

It may now be useful to illustrate examples according to one embodiment.

For example, one example of an event may be received from an application deployed in an enterprise environment is:
{“customerId”:“3825dce6-99d8-434b-bcee-b14f0124d5a6”, “partnerId”:“133ac77a-059a-4b31-bfe0-af1000f071ce”, “domain”:“mxinstall1.test”, “role”: null, “product”:“Email Threat Protection”, “trackingId”:“securityAlert.3825dce6-99d8-434b-bcee-b14f0124d5a6”, “action”:“add”, “priority”:“high”, “aggregation”: {“category”:“securityAlert”, “message”: [{“locale”: “en-US”, “text”:“{N} customers with Security Alerts”}, {“locale”:“en-GB”, “text”:“{N} customers with Security Alerts (en-GB)”}, {“locale”:“de-DE”, “text”:“{N} customers with Security Alerts (de-DE)”}, {“locale”:“es-ES”, “text”:“{N} customers with Security Alerts (es-ES)”}]}, “message”: [{“locale”:“en-US”, “text”:“Mx clean up Uninstall Testing has Security Alert(s)”}, {“locale”:“en-GB”, “text”:“Mx clean up Uninstall Testing has Security Alert(s) (en-GB)”}, {“locale”:“de-DE”, “text”:“Mx clean up Uninstall Testing has Security Alert(s) (de-DE)”}, {“locale”:“es-ES”, “text”:“Mx clean up Uninstall Testing has Security Alert(s) (es-ES)”}], “link”:“ngp/email-security-tools/dashboard?customer=Mx % 20clean %20up %20Uninstall %20Testing”}

The aggregation as obtained from this event and stored at a management platform may be:

```
{
  “_id” : ObjectId(“667accb4f3d574742bf37cfb”),
  “category” : “securityAlert”,
  “product” : “Email Threat Protection”,
  “createdOnDate” : ISODate(“2024-06-25T13:57:08.232Z”),
  “lastUpdatedOnDate” : ISODate(“2024-07-02T19:22:27.996Z”),
  “message” : [
    {
      “locale” : “en-US”,
      “text” : “{N} customers with Security Alerts”
    },
    {
      “locale” : “en-GB”,
      “text” : “{N} customers with Security Alerts (en-GB)”
    },
    {
      “locale” : “de-DE”,
      “text” : “{N} customers with Security Alerts (de-DE)”
    },
    {
      “locale” : “es-ES”,
      “text” : “{N} customers with Security Alerts (es-ES)”
    }
  ]
}
```

Thus, continuing with this example, the above event as stored at a management platform and referring to the above aggregation including that event may be as follows (notice how, according to one embodiment, the aggregation included in the originally received event may be removed (e.g., and stored separately) before the event is stored.

```
{
  “_id” : ObjectId(“667accbef3d574742bf3888b”),
  “partnerId” : “133ac77a-059a-4b31-bfe0-af1000f071ce”,
  “productCode” : “Email Threat Protection”,
  “trackingId” : “securityAlert.3825dce6-99d8-434b-bcee-b14f0124d5a6”,
  “aggregationId” : ObjectId(“667accb4f3d574742bf37cfb”),
  “createdOnDate” : ISODate(“2024-06-25T13:57:18.223Z”),
  “customerId” : “3825dce6-99d8-434b-bcee-b14f0124d5a6”,
  “domain” : “mxinstall1.test”,
  “expireAtDate” : ISODate(“2024-12-31T19:22:17.823Z”),
  “lastUpdatedOnDate” : ISODate(“2024-07-02T19:22:17.823Z”),
  “link” : “ngp/email-security-
tools/dashboard?customer=Mx%20clean%20up%20Uninstall%20Testing”,
  “message” : [
    {
      “locale” : “en-US”,
      “text” : “Mx clean up Uninstall Testing has Security Alert(s)”
    },
    {
      “locale” : “en-GB”,
      “text” : “Mx clean up Uninstall Testing has Security Alert(s) (en-GB)”
    },
    {
      “locale” : “de-DE”,
      “text” : “Mx clean up Uninstall Testing has Security Alert(s) (de-DE)”
    },
    {
      “locale” : “es-ES”,
      “text” : “Mx clean up Uninstall Testing has Security Alert(s) (es-ES)”
    }
  ],
  “priority” : “High”,
  “role” : null
}
```

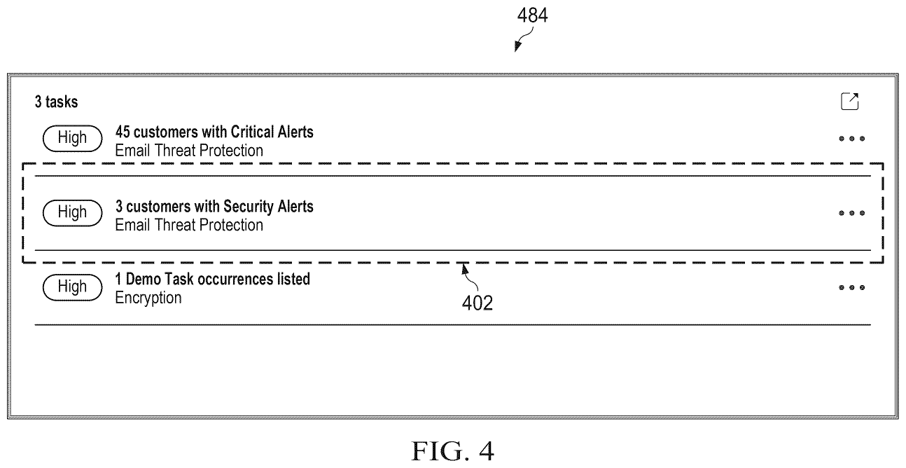

So, continuing with the above example, suppose that the aggregation in which this event is included is associated with two other events. This aggregation may be represented as follows (e.g., using JSON) for rendering in an aggregation area of a provider event interface. Notice here, that the aggregation is associated with the three individual events, while the “message”
for the aggregation is the message included for the aggregation as included in the aggregation in the originally received example event
“{N} customers with Security Alerts”, with the variable
“{N}” being replaced by the number of events (3) for this aggregation. An example of an aggregation area 484 including a portion 402 rendering this aggregation is depicted in FIG. 4. It will be noted that when a user viewing such an aggregation are 484 interactions with a portion 402 of that area corresponding to the aggregation, the user may be able to access (e.g., “drill down”) into the events that comprise that aggregation (e.g., access the messages or links associated with those individual events).

```
{
  “trackingId”: null,
  “product”: “Email Threat Protection”,
  “partnerId”: “133ac77a-059a-4b31-bfe0-af1000f071ce”,
  “customerId”: null,
  “link”: null,
  “message”: “3 customers with Security Alerts”,
  “aggregation”: [
    {
      “trackingId”: “securityAlert.3825dce6-99d8-434b-bcee-b14f0124d5a6”,
      “product”: “Email Threat Protection”,
      “partnerId”: “133ac77a-059a-4b31-bfe0-af1000f071ce”,
      “customerId”: “3825dce6-99d8-434b-bcee-b14f0124d5a6”,
      “link”: “ngp/email-security-
tools/dashboard?customer=Mx%20clean%20up%20Uninstall%20Testing”,
      “message”: “Mx clean up Uninstall Testing has Security Alert(s)”,
      “aggregation”: null,
      “priority”: “High”,
      “createdOnDate”: 1719323838223
    },
    {
      “trackingId”: “securityAlert.a5312fa1-8023-4b38-a448-b14f01242bba”,
      “product”: “Email Threat Protection”,
      “partnerId”: “133ac77a-059a-4b31-bfe0-af1000f071ce”,
      “customerId”: “a5312fa1-8023-4b38-a448-b14f01242bba”,
      “link”: “ngp/email-security-
tools/dashboard?customer=MX%20clean%20up%20Swap%20Testing”,
      “message”: “MX clean up Swap Testing has Security Alert(s)”,
      “aggregation”: null,
      “priority”: “High”,
      “createdOnDate”: 1719323830969
    },
    {
      “trackingId”: “securityAlert.de6cdab3-0d9a-4bc2-806d-afc500faea65”,
      “product”: “Email Threat Protection”,
      “partnerId”: “133ac77a-059a-4b31-bfe0-af1000f071ce”,
      “customerId”: “de6cdab3-0d9a-4bc2-806d-afc500faea65”,
      “link”: “ngp/email-security-
tools/dashboard?customer=delivery%20queue%20testing%20Two”,
      “message”: “delivery queue testing Two has Security Alert(s)”,
      “aggregation”: null,
      “priority”: “High”,
      “createdOnDate”: 1719323830142
    }
  ],
  “priority”: “High”,
  “createdOnDate”: 1719323838223
}
```

Although the invention has been described with respect to specific embodiments thereof, these embodiments are merely illustrative, and not restrictive of the invention as a whole. Rather, the description is intended to describe illustrative embodiments, features, and functions in order to provide a person of ordinary skill in the art context to understand the invention without limiting the invention to any particularly described embodiment, feature, or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods, or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical, or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to:“for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features, and functions in order to provide a person of ordinary skill in the art context to understand the invention without limiting the invention to any particularly described embodiment, feature, or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A system for managing events associated with a plurality of applications provided by a plurality of providers and deployed across one or more enterprises, comprising:
a processor and a non-transitory computer readable medium comprising instructions for:
receiving, at a management platform, events from a plurality of heterogeneous applications deployed across one or more enterprises, wherein each event identifies an enterprise and a provider of an application associated with the event;
storing the events from the multiple heterogeneous applications at the management platform;
receiving a request from the provider identifying the provider;
based on the received request, identifying events associated with the provider as received from the multiple heterogeneous applications deployed across the one or more enterprises; and
presenting the identified events from the multiple heterogeneous application associated with the provider in a provider event interface.

2. The system of claim 1, wherein each event includes a first message included by the application, and presenting the identified events comprises presenting the first messages of the identified events.

3. The system of claim 2, wherein the one or more enterprises comprise multiple distinct enterprises.

4. The system of claim 2, wherein the instructions are further for:
determining a first event of the events includes a first aggregation, wherein the event is associated with the provider and the first aggregation is associated with a category;
storing the first aggregation at the management platform in association with the provider and the first event;
determining a second event of the events includes a second aggregation associated with the category, wherein the second event is associated with the provider;
determining the second event is associated with the stored first aggregation;
storing the second event in association with the first aggregation at the management platform; and
presenting the first aggregation based on the received request.

5. The system of claim 4, wherein the first event is from a first application and the second event is from a second application heterogeneous from the first application.

6. The system of claim 5, wherein the first application is deployed in a first enterprise and the second application is deployed in a second enterprise distinct from the first enterprise.

7. The system of claim 6, wherein:
the first aggregation comprises a first message as included in the first event and the second aggregation comprises a second message as included in the second event;
storing the second event in association with the first aggregation comprises replacing the first message with the second message; and
wherein presenting the first aggregation comprises presenting the second message in association with the first aggregation.

8. A method, comprising:
receiving, at a management platform, events from a plurality of heterogeneous applications deployed across one or more enterprises, wherein each event identifies an enterprise and a provider of an application associated with the event;
storing the events from the multiple heterogeneous applications at the management platform;
receiving a request from the provider identifying the provider;
based on the received request, identifying events associated with the provider as received from the multiple heterogeneous applications deployed across the one or more enterprises; and
presenting the identified events from the multiple heterogeneous application associated with the provider in a provider event interface.

9. The method of claim 8, wherein each event includes a first message included by the application, and presenting the identified events comprises presenting the first messages of the identified events.

10. The method of claim 9, wherein the one or more enterprises comprise multiple distinct enterprises.

11. The method of claim 9, further comprising:
determining a first event of the events includes a first aggregation, wherein the event is associated with the provider and the first aggregation is associated with a category;
storing the first aggregation at the management platform in association with the provider and the first event;
determining a second event of the events includes a second aggregation associated with the category, wherein the second event is associated with the provider;
determining the second event is associated with the stored first aggregation;
storing the second event in association with the first aggregation at the management platform; and
presenting the first aggregation based on the received request.

12. The method of claim 11, wherein the first event is from a first application and the second event is from a second application heterogeneous from the first application.

13. The method of claim 12, wherein the first application is deployed in a first enterprise and the second application is deployed in a second enterprise distinct from the first enterprise.

14. The method of claim 13, wherein:
the first aggregation comprises a first message as included in the first event and the second aggregation comprises a second message as included in the second event;
storing the second event in association with the first aggregation comprises replacing the first message with the second message; and
wherein presenting the first aggregation comprises presenting the second message in association with the first aggregation.

15. A non-transitory computer readable medium, comprising instructions for:
receiving, at a management platform, events from a plurality of heterogeneous applications deployed across one or more enterprises, wherein each event identifies an enterprise and a provider of an application associated with the event;
storing the events from the multiple heterogeneous applications at the management platform;
receiving a request from the provider identifying the provider;
based on the received request, identifying events associated with the provider as received from the multiple heterogeneous applications deployed across the one or more enterprises; and
presenting the identified events from the multiple heterogeneous application associated with the provider in a provider event interface.

16. The non-transitory computer readable medium of claim 15, wherein each event includes a first message included by the application, and presenting the identified events comprises presenting the first messages of the identified events.

17. The non-transitory computer readable medium of claim 16, wherein the one or more enterprises comprise multiple distinct enterprises.

18. The non-transitory computer readable medium of claim 16, wherein the instructions are further for:
determining a first event of the events includes a first aggregation, wherein the event is associated with the provider and the first aggregation is associated with a category;
storing the first aggregation at the management platform in association with the provider and the first event;
determining a second event of the events includes a second aggregation associated with the category, wherein the second event is associated with the provider;
determining the second event is associated with the stored first aggregation;
storing the second event in association with the first aggregation at the management platform; and
presenting the first aggregation based on the received request.

19. The non-transitory computer readable medium of claim 18, wherein the first event is from a first application and the second event is from a second application heterogeneous from the first application.

20. The non-transitory computer readable medium of claim 19, wherein the first application is deployed in a first enterprise and the second application is deployed in a second enterprise distinct from the first enterprise.

21. The non-transitory computer readable medium of claim 20, wherein:
the first aggregation comprises a first message as included in the first event and the second aggregation comprises a second message as included in the second event;
storing the second event in association with the first aggregation comprises replacing the first message with the second message; and
wherein presenting the first aggregation comprises presenting the second message in association with the first aggregation.
